(19) United States
(12) Patent Application Publication
(10) Pub. No.: US 2025/0139119 A1
(43) Pub. Date: May 1, 2025

(54) SYSTEMS AND METHODS FOR DETERMINING DIFFERENCES BETWEEN VECTOR DATASETS

(71) Applicant: Woven by Toyota, Inc., Tokyo (JP)

(72) Inventors: Edward Higgins, Redmond, WA (US); Matthew R. Sayler, Tacoma, WA (US); Jaspal Singh, Hicksville, NY (US)

(73) Assignee: Woven by Toyota, Inc., Tokyo (JP)

(21) Appl. No.: 18/495,235

(22) Filed: Oct. 26, 2023

(51) Int. Cl. G06F 16/26; G01S 17/89

(52) U.S. Cl. CPC G06F 16/26; G01S 17/89

(57) ABSTRACT

In one embodiment, a method of determining changes between a first vector dataset and a second vector dataset includes receiving the first vector dataset and the second vector dataset, where each of the first vector dataset and the second vector dataset includes a plurality of features, each feature being defined by at least one vertex. The method also includes for each feature in the first vector dataset and the second vector dataset, generating a signature key based on geometric attributes of each feature, storing the signature key for each feature of the first vector dataset in a first data structure, storing the signature key for each feature of the second vector dataset in a second data structure, and comparing the first data structure to the second data structure to determine differences between the first vector dataset and the second vector dataset.

### BACKGROUND

High-definition maps are three-dimensional maps that include features derived from vector datasets resulting from light detection and ranging (LiDAR) scans of an environment. The LiDAR scan results in a point cloud of LiDAR points within the environment. Features, such as roads, buildings, signs and the like may be represented by polygons that consist of a collection of ordered, interconnected vertices. Two vector datasets resulting from the a LiDAR scan may be generated. For example, the data of a vector dataset may be manipulated by an operator to create a new vector dataset that is an altered version of a parent vector dataset.

However the different vector datasets are created, there may be differences between the two vector datasets.

For a variety of reasons, it may be beneficial to quickly and accurately determine differences between two vector datasets. For example, an engineer may want to know what changed between two vector datasets to quantify differences in the high-definition map. Presently, it is a tedious process to identify the changes between two vector datasets.

Accordingly, a need exists for alternative methods of identifying changes between vector datasets.

### BRIEF SUMMARY

In one aspect, a method of determining changes between a first vector dataset and a second vector dataset, the method includes receiving, by a processor, the first vector dataset and the second vector dataset, where each of the first vector dataset and the second vector dataset includes a plurality of features, each feature being defined by at least one vertex, for each feature of the plurality of features in the first vector dataset and the second vector dataset, generating a signature key based on geometric attributes of each feature, storing the signature key for each feature of the plurality of features of the first vector dataset in a first data structure, storing the signature key for each feature of the plurality of features of the second vector dataset in a second data structure, and comparing the first data structure to the second data structure to determine features that are present in the first vector dataset and not present in the second vector dataset and features that are present in the second vector dataset and not present in the first vector dataset.

In one aspect, a computing apparatus includes a processor. The computing apparatus also includes a memory storing instructions that, when executed by the processor, configure the apparatus to receive, by a processor, the first vector dataset and the second vector dataset, where each of the first vector dataset and the second vector dataset includes a plurality of features, each feature being defined by at least one vertex, for each feature of the plurality of features in the first vector dataset and the second vector dataset, generate a signature key based on geometric attributes of each feature, store the signature key for each feature of the plurality of features of the first vector dataset in a first data structure, store the signature key for each feature of the plurality of features of the second vector dataset in a second data structure, compare the first data structure to the second data structure to determine features that are present in the first vector dataset and not present in the second vector dataset and features that are present in the second vector dataset and not present in the first vector dataset.

In one aspect, a method of determining changes between a first vector dataset and a second vector dataset, the method includes receiving, by a processor, the first vector dataset and the second vector dataset, where each of the first vector dataset and the second vector dataset includes a plurality of features, each feature being defined by at least one vertex. The method also includes for each feature of the plurality of features in the first vector dataset and the second vector dataset, generating a signature key based on geometric attributes of each feature, each signature key includes a first vertex and a second vertex defining a bounding box, a number of vertices of the feature, a total azimuth value, and a total length value, where the total azimuth value includes a summation of an azimuth between successive vertices of the feature, and the total length value includes a summation of a length of segments between successive vertices of the feature. The method also includes storing the signature key for each feature of the plurality of features of the first vector dataset in a first data structure. The method also includes storing the signature key for each feature of the plurality of features of the second vector dataset in a second data structure. The method also includes comparing the first data structure to the second data structure to determine features that are present in the first vector dataset and not present in the second vector dataset and features that are present in the second vector dataset and not present in the first vector dataset.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an environment according to one or more embodiments described and illustrated herein.

FIG. 2 illustrates an example feature according to one or more embodiments described and illustrated herein.

FIG. 3 illustrates an example map of differences between two vector datasets displayed on an electronic display according to one or more embodiments described and illustrated herein.

FIG. 4 illustrates an example computing system for determining differences between two vector datasets.

### DETAILED DESCRIPTION

Embodiments of the present disclosure are directed to computer apparatuses and methods for determining changes between two different vector datasets. For any number of reasons, differences may exist between two vector datasets corresponding to the same environment. A user, such as a data scientist, engineer, or designer, may need to identify the differences between the two vector datasets for one reason or another. Embodiments of the present disclosure allow fast and computationally efficient methods of determining changes between two vector datasets by storing, for each vector dataset, a data structure storing a signature key for each feature within the respective vector dataset. The data structures for each vector dataset are compared to identify differences between the two. For example, the second data structure is searched for each signature key stored within the first data structure. If a signature key in the first data structure is not found in the second data structure, the feature associated with the particular signature key has either been changed or is no longer present in the second vector dataset. The same process can be completed in reverse wherein the first data structure is searched for each signature key stored within the second data structure. A log may be created to quantify and locate differences on a map.

Various embodiments for computer apparatuses and methods for determining changes between two different vector datasets are described in detail below.

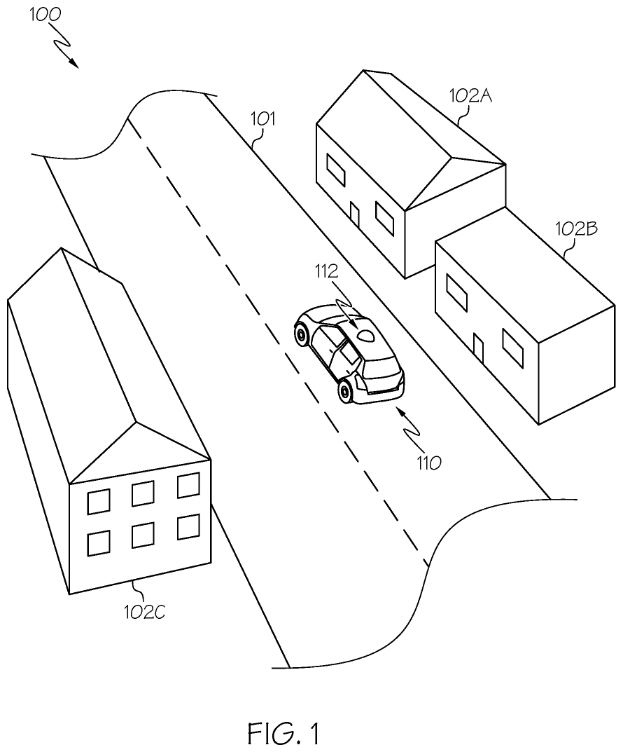

Referring now to FIG. 1, an example environment 100 for LiDAR data is being generated by a LiDAR scanning system 112 is illustrated. The environment 100 includes a road 101, buildings 102A-102C and any other features, such as signs, curbs, trees, lane lines, and the like. In the illustrated embodiment, the LiDAR scanning system 112 is mounted on a vehicle 110, which drives through the environment 100. However, it should be understood that the LiDAR scanning system 112 may be operated without being positioned on a vehicle. The LiDAR scanning system 112 emits an array of infrared beams, and detects the return of the beams and their times of flight to generate a point cloud of LiDAR points in three-dimensional space.

Features within the environment, such as the road 101 and buildings 102A-102C, are represented by points within the point cloud. These features can then be further defined as polygons, where vertices of the polygons are derived from individual points of the point cloud. These polygons and their points are stored in a vector dataset.

Vector datasets may be manipulated manually or according to various algorithms. Manipulation may change the shape of features between the two vector datasets, or may remove or add features entirely.

To enable the ability to search for differences between two vector datasets, signature keys for each feature are generated and stored in a data structure corresponding to each vector dataset. Thus, a first data structure stores a list of signature keys corresponding to features found within a first vector dataset, and a second data structure stores a list of signature keys corresponding to features found within a second vector dataset.

The signature keys are derived from geometric attributes of the features themselves. The geometric attributes of a feature forms a unique fingerprint for the feature. Thus, the signature key can be used to uniquely identify the feature in another vector dataset.

The signature key may include any number of tokens representing different geometric attributes. As a non-limiting example, the signature key may include one or more of coordinates for particular vertices of the feature, a number of vertices, azimuth values between vertices, length values of segments between vertices, and elevation of the vertices. These tokens may be individually stored and associated with a signature key. In some embodiments, the tokens may be summed together to generate a single hash value.

A non-limiting signature key may be (VC₁, VC₂, N, A_{T}, L_{T}, Z_{T}), where:
VC₁ is a coordinate of a lower-left vertex of a feature's bounding box,
VC₂ is a coordinate of an upper-right vertex of the feature's bounding box,
N is the total number of vertices of the feature,
A_{T} is a total azimuth change between successive vertices of the feature,
L_{T} is a total length of segments between the vertices of the feature, and
Z_{T} is a total elevation of the vertices of the feature.

It should be understood that the above-example is only one configuration for the signature key, and that others are possible. For example, the tokens above may be arranged in a different order, or more or fewer tokens may be included in the signature key.

Using the signature key above, an example signature key is (−81.93519516600003, 28.849425929; −81.93478115899995, 28.85074578500013); 4; 578.1741659594979; 334.4290976623049; −2115.7274136543274). In this example, the signature key for the feature is in a roadway layer, and thus the signature key represents a particular roadway feature. This signature key may be stored in a first data structure along with many other features found in a first vector dataset.

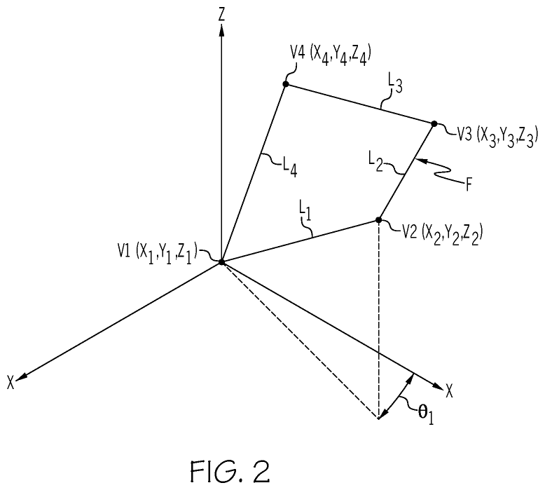

FIG. 2 illustrates a simple four-vertices feature F to show how a signature key may be generated. The feature F has a first vertex V₁, a second vertex V₂, a third vertex V₃, and a fourth vertex V₄. Using the example signature key above, the first vertex V₁ is selected as VC₁ as it is the lower-left vertex, and the third vertex V₃ is selected as VC₂. There are four vertices and thus N=4.

One way to determine the total azimuth change A_{T} is to perform a summation of the azimuth change between all of the successive vertices of the feature's geometry. This is performed by sum of the first vertex V₁ to the second vertex V₂ azimuth angle θ₁ (i.e., the compass heading angle between the first vertex V₁ and the second vertex V₂), the second vertex V₂ to the third vertex V₃ azimuth angle θ₂, the third vertex V₃ to the fourth vertex V₄ azimuth angle θ₁ and so on. The result of the summation is stored at the total azimuth change A_{T} in the signature key.

The total length of segments L_{T} may be determined by summing the length of each segment between successive vertices of the feature's geometry. In the example illustrated by FIG. 2, L_{T}=L₁+L₂+L₃+L₄. This value is then stored in the signature key as L_{T}.

The total elevation Z_{T} is the cumulative elevation (Z) value in meters for all vertices of the feature's geometry. Each vertex has a Z coordinate, and Z_{T} is the summation of the Z coordinate values. In the example of FIG. 2, Z_{T}=Z₁+Z₂+Z₃+Z₄. The resulting value is then stored in the signature key.

It is noted that embodiments of the present disclosure also support single-point geometry types. That is, a feature that is represented by a single point. In this case, the first vertex V₁ and a second vertex V₂ representing the bounding box are equal to one another and represent the coordinates of the single point. Additionally, the total number of vertices token N is equal to one, the total azimuth token A_{T} it is equal to zero, the total segment length token L_{T} is equal to zero, and the total elevation token Z_{T} it is equal to the z-axis value of the coordinate of the single point.

A signature key for each feature within the dataset is generated and stored in a data structure. When a new version of the vector dataset is created, e.g., manipulation of the vector dataset, signature keys for features within the new version of the vector dataset are created and then stored in a different data structure. Thus, signatures keys for features found in a first vector dataset are stored in a first data structure and signature keys for features found in a second vector dataset are stored in a second data structure.

The various data structures may be compared to identify differences between two corresponding vector datasets. For example, with the signature key collection of the first data structure, the processor of the system may iterate through the individual signature keys of the first data structure for identical signature keys stored within the second data structure. The individual tokens of two signature keys are compared. For example, for a match, the same values for VC₁, VC₂, N, A_{T}, L_{T}, and Z_{T} may be found. In some embodiments, the system is flexible whereby a match is found when some threshold number or percentage of tokens match between two compared signature keys. In one example, all of the tokens except for the number of vertices N may be equal. The system may indicate these two signature keys to be matches. The system may give the user the ability to set rules for what constitutes a match.

When a first data structure represents an earlier first vector dataset, and a signature key of the first data structure is not found in the second data structure, the corresponding feature was either removed or changed.

The process can also be performed in reverse. With the signature key collection of the second data structure, the processor of the system may iterate through the individual signature keys of the second data structure for identical signature keys stored within the first data structure. When a first data structure represents an earlier first vector dataset, and a signature key of the second data structure is not found in the first data structure, the corresponding feature was either updated from the previous version or newly added.

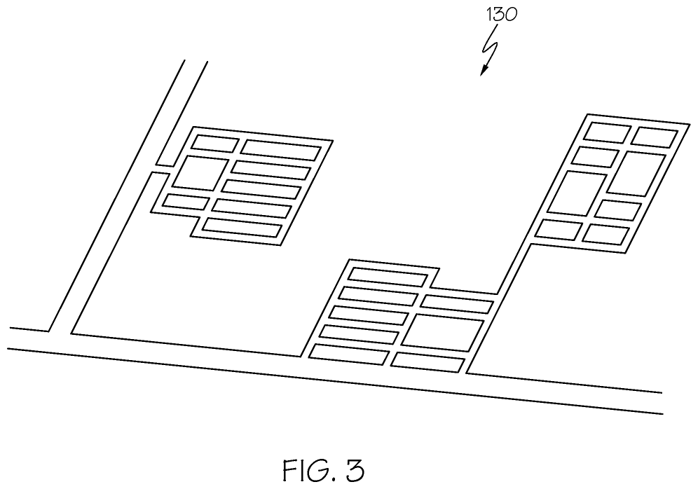

Thus, the systems and methods described herein provide the ability to quickly and efficiently find changes or differences between two vector datasets. In some embodiments, the differences between the two vector datasets may be displayed in a graphical user interface on an electronic display. FIG. 3 illustrates graphical user interface 130 of a map showing differences between a first vector dataset and a second vector dataset. The map may be made of the differences between vector datasets. For example, the map may show features found in an earlier first vector dataset that are not found in a later second vector dataset. As another example, the map may show features that are found in the later second vector dataset but not found in the earlier first vector dataset. Users may zoom into the map of the graphical user interface 130 and see individual features, for example.

A user may use the visualization for any number of reasons. The user may see significant changes, and may then request a vendor that created the vector dataset investigate the source of the changes for validation purposes. Some embodiments may enable a user to select a feature in the vector dataset, and allow a user to adjust the vector dataset with respect to the selected feature.

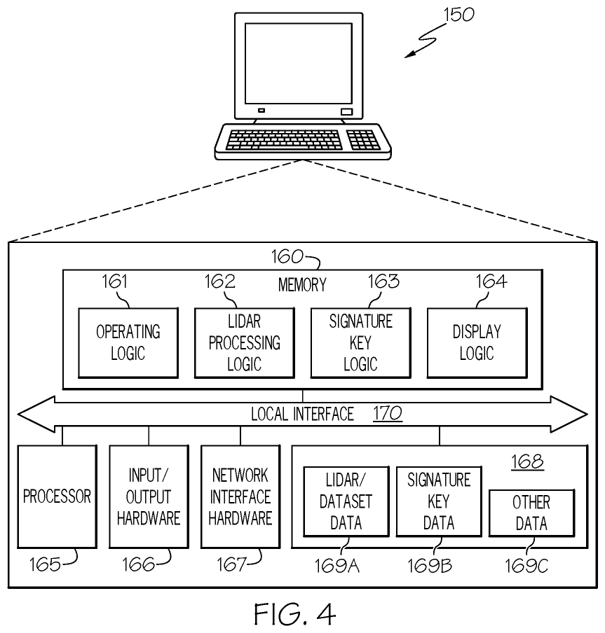

Embodiments of the present disclosure may be implemented by a computing device, and may be embodied as computer-readable instructions stored on a non-transitory memory device. Referring now to FIG. 4, an example system for determining changes between a first vector dataset and a second vector dataset is schematically illustrated. The example computing device 150 provides a system for determining changes between a first vector dataset and a second vector dataset, and/or a non-transitory computer usable medium having computer readable program code for determining changes between a first vector dataset and a second vector dataset embodied as hardware, software, and/or firmware, according to embodiments shown and described herein. While in some embodiments, the computing device 150 may be configured as a general purpose computer with the requisite hardware, software, and/or firmware, in some embodiments, the computing device 150 may be configured as a special purpose computer designed specifically for performing the functionality described herein. It should be understood that the software, hardware, and/or firmware components depicted in FIG. 4 may also be provided in other computing devices external to the computing device 150 (e.g., data storage devices, remote server computing devices, and the like).

As also illustrated in FIG. 4, the computing device 150 (or other additional computing devices) may include a processor 165, input/output hardware 166, network interface hardware 167, a data storage component 168 (which may include LiDAR and/or vector dataset data 169A, signature key data 169B (e.g., data structures storing the signature key data), and any other data 169C for performing the functionalities described herein), and a non-transitory memory component 160. The memory component 160 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

Additionally, the memory component 160 may be configured to store operating logic 161, LiDAR processing logic 162 for receiving and processing LiDAR data from a LiDAR scanning system, signature key logic 163 for generating signature keys for features, and display logic 164 for rendering displays based on vector dataset differences, as described herein (each of which may be embodied as computer readable program code, firmware, or hardware, as an example). It should be understood that the data storage component 168 may reside local to and/or remote from the computing device 150, and may be configured to store one or more pieces of data for access by the computing device 150 and/or other components.

A local interface 170 is also included in FIG. 4 and may be implemented as a bus or other interface to facilitate communication among the components of the computing device 150.

The processor 165 may include any processing component configured to receive and execute computer readable code instructions (such as from the data storage component 168 and/or memory component 160). The input/output hardware 166 may include one or more of graphics display device, keyboard, mouse, printer, camera, microphone, speaker, touch-screen, and/or other device for receiving, sending, and/or presenting data. The network interface hardware 167 may include any wired or wireless networking hardware, such as a modem, LAN port, wireless fidelity (Wi-Fi) card, WiMax card, mobile communications hardware, and/or other hardware for communicating with other networks and/or devices. The network interface hardware 167 may communicate via the Internet to receive vehicle data 122 provided from one or more sources as well as communicate with a display device, such as virtual reality headset 124 to display the virtual vehicle and virtual environment.

Included in the memory component 160 may be the operating logic 161, LiDAR processing logic 162, signature key logic 163, and display logic 164. The operating logic 161 may include an operating system and/or other software for managing components of the computing device 150. The operating logic 161 may also include computer readable program code for displaying the graphical user interface. Similarly, the LiDAR processing logic 162 may reside in the memory component 160 and may be configured to receive and process LiDAR data, such as to generate vector datasets. The signature key logic 163 also may reside in the memory component 160 and may be configured to generate signature keys from the vector datasets and store them in data structures. The display logic 164 includes logic to generate a display based on differences between vector datasets.

The components illustrated in FIG. 4 are merely exemplary and are not intended to limit the scope of this disclosure. More specifically, while the components in FIG. 4 are illustrated as residing within the computing device 150, this is a non-limiting example. In some embodiments, one or more of the components may reside external to the computing device 150.

It should now be understood that embodiments of the present disclosure are directed to systems and methods for detecting differences between vector datasets derived from LiDAR data. Embodiments generate signature keys for features found in two related vector datasets. The signature keys from each vector dataset may be compared with one another to find the differences between the vector datasets. Action may be taken based on the detected differences, such as display of the differences and generation of instructions to make data corrections.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method of determining changes between a first vector dataset and a second vector dataset, the method comprising:
receiving, by a processor, the first vector dataset and the second vector dataset, wherein each of the first vector dataset and the second vector dataset comprises a plurality of features contained within a respective high-definition LiDAR map of an environment of a vehicle, each feature being defined by at least one vertex;
for each feature of the plurality of features in the first vector dataset and the second vector dataset, generating a signature key based on geometric attributes of each feature;
storing the signature key for each feature of the plurality of features of the first vector dataset in a first data structure;
storing the signature key for each feature of the plurality of features of the second vector dataset in a second data structure; and
comparing the signature keys in the first data structure with the signature keys in the second data structure to determine features that are present in the first vector dataset and not present in the second vector dataset and features that are present in the second vector dataset and not present in the first vector dataset.

2. The method of claim 1, further comprising displaying, in a graphical user interface, at least one of the features that are present in the first vector dataset and not present in the second vector dataset and the features that are present in the second vector dataset and not present in the first vector dataset.

3. The method of claim 1, further comprising scanning an environment using a LiDAR scanning system, and
creating the respective high-definition LiDAR map based on results of the scan, wherein the first vector dataset and the second vector dataset are based on the respective high-definition LiDAR map.

4. The method of claim 1, further comprising:
receiving a selection of a feature that is present in the first vector dataset and not present in the second vector dataset or present in the second vector dataset and not present in the first vector dataset; and
adjusting vector data in at least one of the first vector dataset and the second vector dataset.

5. The method of claim 1, wherein each signature key comprises at least one azimuth value that is greater than or equal to zero and at least one length value that is greater than or equal to zero.

6. The method of claim 1, wherein each signature key comprises, for a corresponding feature, a first vertex, a second vertex, a number of vertices, a total azimuth value, a total length value, and a total elevation value.

7. The method of claim 6, wherein the first vertex and the second vertex define upper and lower corners of a bounding box surrounding the corresponding feature.

8. A computing apparatus comprising:
a processor; and
a memory storing instructions that, when executed by the processor, cause the apparatus to:
receive a first vector dataset and a second vector dataset, wherein each of the first vector dataset and the second vector dataset comprises a plurality of features contained within a respective high-definition LiDAR map of an environment of a vehicle, each feature being defined by at least one vertex;
for each feature of the plurality of features in the first vector dataset and the second vector dataset, generate a signature key based on geometric attributes of each feature;
store the signature key for each feature of the plurality of features of the first vector dataset in a first data structure;
store the signature key for each feature of the plurality of features of the second vector dataset in a second data structure;
compare the signature keys in the first data structure with the signature keys in the second data structure to determine features that are present in the first vector dataset and not present in the second vector dataset and features that are present in the second vector dataset and not present in the first vector dataset.

9. The computing apparatus of claim 8, wherein the instructions further cause the apparatus to display, in a graphical user interface, at least one of the features that are present in the first vector dataset and not present in the second vector dataset and the features that are present in the second vector dataset and not present in the first vector dataset.

10. The computing apparatus of claim 8, wherein the instructions further cause the apparatus to receive the respective high-definition LiDAR map from a LiDAR scanning system, wherein the first vector dataset and the second vector dataset are based on the respective high-definition LiDAR map.

11. The computing apparatus of claim 8, wherein the instructions further cause the apparatus to:
receive a selection of a feature that is present in the first vector dataset and not present in the second vector dataset or present in the second vector dataset and not present in the first vector dataset; and
adjust vector data in at least one of the first vector dataset and the second vector dataset.

12. The computing apparatus of claim 8, wherein each signature key comprises at least one azimuth value that is greater than or equal to zero and at least one length value that is greater than or equal to zero.

13. The computing apparatus of claim 8, wherein each signature key comprises, for a corresponding feature, a first vertex, a second vertex, a number of vertices, a total azimuth value, a total length value, and a total elevation value.

14. The computing apparatus of claim 13, wherein the first vertex and the second vertex define upper and lower corners of a bounding box that surrounds the corresponding feature.

15. A method of determining changes between a first vector dataset and a second vector dataset, the method comprising:
receiving, by a processor, the first vector dataset and the second vector dataset, wherein each of the first vector dataset and the second vector dataset comprises a plurality of features contained within a respective high-definition LiDAR map of an environment of a vehicle, each feature being defined by at least one vertex;
for each feature of the plurality of features in the first vector dataset and the second vector dataset, generating a signature key based on geometric attributes of each feature, each signature key comprising a first vertex and a second vertex defining a bounding box, a number of vertices of the feature, a total azimuth value, a total length value, and a total elevation value, wherein:
the total azimuth value comprises a summation of an azimuth between successive vertices of the feature;
the total length value comprises a summation of a length of segments between successive vertices of the feature; and
the total elevation value comprises a summation of an elevation for each vertex;
storing the signature key for each feature of the plurality of features of the first vector dataset in a first data structure;
storing the signature key for each feature of the plurality of features of the second vector dataset in a second data structure; and
comparing the signature keys in the first data structure with the signature keys in the second data structure to determine features that are present in the first vector dataset and not present in the second vector dataset and features that are present in the second vector dataset and not present in the first vector dataset.

16. The method of claim 15, further comprising displaying, in a graphical user interface, at least one of the features that are present in the first vector dataset and not present in the second vector dataset and the features that are present in the second vector dataset and not present in the first vector dataset.

17. The method of claim 15, further comprising scanning an environment using a LiDAR scanning system, and
creating the respective high-definition LiDAR map based on results of the scan, wherein the first vector dataset and the second vector dataset are based on the respective high-definition LiDAR map.

18. The method of claim 15, further comprising:
receiving a selection of a feature that is present in the first vector dataset and not present in the second vector dataset or present in the second vector dataset and not present in the first vector dataset; and
adjusting vector data in at least one of the first vector dataset and the second vector dataset.

19. The computing apparatus of claim 8, further comprising:
characterizing, based on those features that are present in the first vector dataset and not present in the second vector dataset and those features that are present in the second vector dataset and not present in the first vector dataset, differences between a means by which the first vector dataset was created from the respective high-definition LiDAR map and a means by which the second vector dataset was created from the respective high-definition LiDAR map.
